(19) United States
(12) Patent Application Publication
(10) Pub. No.: US 2012/0070357 A1
(43) Pub. Date: Mar. 22, 2012

(54) METHOD FOR THE PREPARATION OF BORON NITRIDE POWDER

(76) Inventors: Emanual Prilutsky, Kiev (UA); Oleg Prilutsky, Kibbutz Ruhama (IL); Dan Yardeni, Ramat Gan (IL)

(21) Appl. No.: 13/257,541

(22) PCT Filed: Mar. 17, 2010
(86) PCT No.: PCT/IL10/00220

§ 371 Date: Nov. 24, 2011

Related U.S. Application Data
(60) Provisional application No. 61/161,603, filed on Mar. 19, 2009.

(51) Int. Cl. C01B 21/064

(52) U.S. Cl. 423/290

(57) ABSTRACT

This invention is directed to a process for the preparation of boron nitride powder, particularly a fine powder with a low degree of contamination, which demonstrates good caking, heat conductivity and dielectric properties. Specifically, a process for the preparation of amorphous boron nitride (a-BN) is provided wherein the process comprises: mixing powders of boric acid and a carbamide at a temperature in the range of about 250-300° C., thereby forming: ammonium polyborates; boron imide or a mixture thereof and ammonia; and heating of the materials formed in step (a) to a temperature in the range of about 500-600° C., thereby forming a powder of a-BN.

### FIELD OF THE INVENTION

This invention is directed to a process for the preparation of boron nitride powder, particularly a fine powder with a low degree of contamination, which demonstrates good caking, heat conductivity and dielectric properties.

### BACKGROUND OF THE INVENTION

Ceramic materials, such as boron nitride (BN), have useful properties including high melting temperature, low density, high strength, stiffness, hardness, wear resistance, and corrosion resistance. Many ceramics are good electrical and thermal insulators.

For most applications using ceramics, a fine powder with small particle sizes, as small as nano-sized particles, is required. Small particle-size powders are not easily obtained by current methodology and usually require additional grinding and cleaning operations.

Boron nitride (BN) is a white powder with high chemical and thermal stability and high electrical resistance. Boron nitride possesses three polymorphic forms; one analogous to diamond, one analogous to graphite and one analogous to fullerenes. Boron nitride can be used to make crystals that are extremely hard, second in hardness only to diamond, and the similarity of this compound to diamond extends to other applications. Like diamond, boron nitride acts as an electrical insulator and is an excellent conductor of heat.

Boron nitride, like graphite, has the ability to lubricate, in both extreme cold and hot conditions, is suited for extreme pressure applications, is environmentally friendly and is inert to most chemicals powders.

Due to its excellent dielectric and insulating properties, BN is used in electronics, e.g. as a substrate for semiconductors, microwave-transparent windows, structural material for seals, electrodes as well as catalyst carriers in fuel cells and batteries.

BN can be prepared as amorphous BN (a-BN), hexagonal BN (h-BN), turbostratic BN (t-BN) and cubic BN (c-BN). Generally, a-BN is prepared at relatively low temperatures, while both h-BN and t-BN are prepared at higher temperatures. c-BN may be prepared by high pressure and high temperature treatment of h-BN.

There are several known processes in the art for preparing BN powders, such as those presented in U.S. Pat. No. 6,306,358. However, the methods known in the art are generally inefficient, and tend to produce powders that need to be cleaned and/or ground before used. U.S. Pat. No. 6,306,358, for example, discloses a method for preparing a-BN powder at temperature below 1000° C., mostly in the range of 850-950° C. However, since boric anhydride (B₂O₃), which is one of the reactants in the process, evaporates at such high temperatures, the yield of the process is relatively low.

Therefore, there is a need in the art for a process for preparing various forms of BN, which would be efficient, and would provide pure powders.

### SUMMARY OF THE INVENTION

This invention is directed to a process for the preparation of amorphous boron nitride (a-BN) comprising:
a. Mixing powders of boric acid and a carbamide at a temperature in the range of about 250-300° C., thereby forming: ammonium polyborates; boron imide or a mixture thereof and ammonia; and
b. heating of the materials formed in step (a) to a temperature in the range of about 500-600° C., thereby forming a powder of a-BN.

### BRIEF DESCRIPTION OF THE DRAWINGS

FIG. 1a shows a-BN powder;

FIG. 1b shows an example of an X-ray powder diffraction diagram of a-BN according to an embodiment of the invention;

FIG. 2: shows an example of an X-ray powder diffraction diagram of h-BN/t-BN XRD diagram;

FIGS. 3a-b: represents EM photomicrographs showing h-BN/t-BN powder, showing the high degree of purity thereof;

FIGS. 4a-b shows tables describing physical and chemical properties of the h-BN/t-BN powder.

FIG. 5 shows calorimetric analysis of the process according to an embodiment of the invention.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

This invention provides a process for the preparation of ceramic powders of BN. In one embodiment of this invention, the prepared BN is amorphous BN, i.e., a-BN.

The a-BN is prepared according to this invention by the following steps: mixing powders of boric acid and a nitrogen comprising compound at a temperature in the range of about 250-300° C., thereby forming: ammonium polyborates ((NH₄)ₓB_{y}O_{z}); boron imide, or a mixture thereof and ammonia; and heating of the ammonium polyborates and the boron imide formed to a temperature in the range of about 500-600° C., thereby forming a powder of a-BN. By “about” it is meant plus or minus 30%, 20% , 10% or 5%.

A compound containing nitrogen may be for example, ammonia, ammonium and carbamides, including urea.

The a-BN is prepared according to an embodiment of this invention by the following steps:
mixing powders of boric acid and a carbamide, such as urea ((NH₂)₂CO, at a temperature in the range of about 250-300° C., thereby forming: ammonium polyborates ((NH₄)ₓB_{y}O_{z}); boron imide, or a mixture thereof and ammonia; and
subsequent heating of the ammonium polyborates and the boron imide formed to a temperature in the range of about 500-600° C., thereby forming a powder of a-BN.

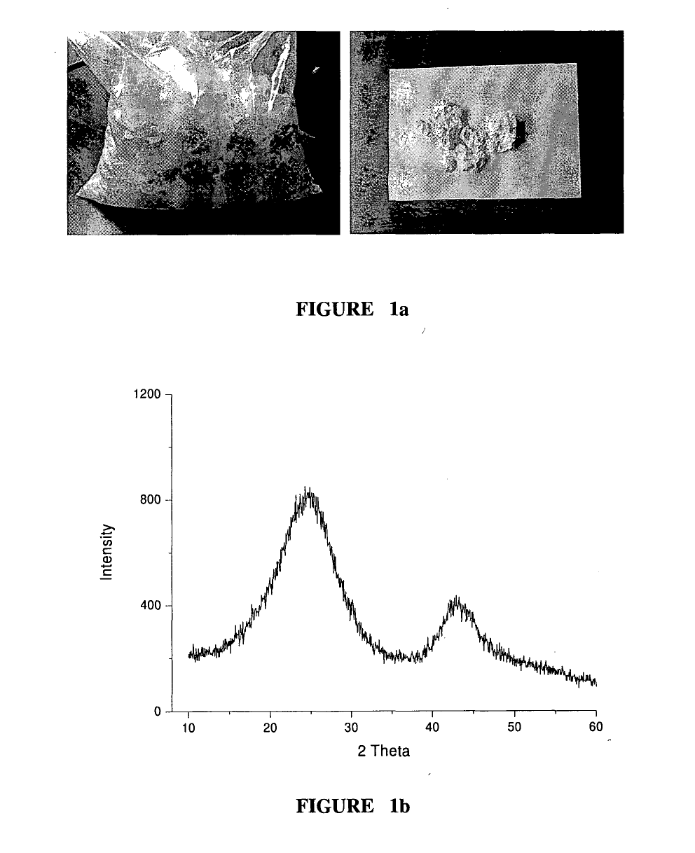

FIG. 1a shows the a-BN provided by the process of this invention and FIG. 1b shows the XRD diagram of the prepared a-BN.

According to this invention, the ammonium polyborates react with the ammonia when heated to about 500-600° C. thereby forming a-BN. Further, according to this invention heating the boron imide to about 500-600° C. provides a-BN.

According to this invention, the second step of the above process is performed when about less than 50% of the initial weight of the boric acid reactant remains in the reaction vessel. According to another embodiment the second step of the above process is performed when about 55-75% of the initial weight of the boric acid reactant remains in the reaction vessel. According to a further embodiment of the invention, the second step is performed when about 60-65% of the initial weight of the boric acid reactant remains. According to a further embodiment of the invention, the second step is performed when about 70% of the initial weight of the boric acid reactant remains in the reaction vessel. According to a further embodiment of the invention, the second step is performed when about 40-50% of the initial weight of the boric acid reactant remains in the reaction vessel. According to a further embodiment of the invention, the second step is performed when about 30-40% of the initial weight of the boric acid reactant remains in the reaction vessel. According to a further embodiment of the invention, the second step is performed when about 20-30% of the initial weight of the boric acid reactant remains in the reaction vessel. According to a further embodiment of the invention, the second step is performed when about 10-20% of the initial weight of the boric acid reactant remains in the reaction vessel. The term “about” is used herein to mean ±10%.

In one embodiment of this invention, the boric acid is selected from H₃BO₃, H₂B₄O₇ or HBO₂. In another embodiment of the invention, salts of boric acid may be used instead of the boric acid.

According to an embodiment of the invention, the chemical formula of the ammonium polyborates is (NH₄)ₓB_{y}O_{z}, wherein x is between 1-4, y is between 1-10 and z is between 2-17. The ammonium polyborates may, for example, without being limited, (NH₄)₂B₄O₇, NH₄B₅O₈ or (NH₄)₄B₁₀O₁₇. According to an embodiment of the invention, any of the polyborates may be hydrated. According to an embodiment of this invention, when the carbamide reactant is urea, the ammonium polyborate formed may be ammonium tetraborate. According to this embodiment, the chemical reactions that may take place in the reaction vessel in the first step of the above process are:

4H₃BO₃+(NH₂)₂CO [symbol] (NH₄)₂B₄O₇+CO₂+4H₂O

4H₃BO₃+3(NH₂)₂CO [symbol] 2B₂(NH)₃+3CO₂+9H₂O

2H₃BO₃ [symbol] H B₂O₃+3H₂O

Additionally, part of the urea in the reaction vessel reacts with the water produced in the above reactions thereby forming ammonia according to the following reaction:

(NH₂)₂CO+H₂O [symbol] 2NH₃+CO₂

Then, in the second step, upon heating to about 500-600° C., the ammonium tetraborate reacts with ammonia, thereby forming a-BN, according to the following reaction:

(NH₄)₂B₄O₇+NH₃→4a−BN+7H₂O

Further, the boron imide produced in the first step breaks down, upon heating to 500-600° C., to a-BN and ammonia according to the following reaction:

B₂(NH)₃→2a−BN+NH₃

thus providing a-BN and additional ammonia that may react with ammonium tetraborate for the formation of further a-BN.

According to an embodiment of the invention, the w/w ratio of the carbamide and the boric acid reactants is from about 3:4 to 2:1. According to a further embodiment of the invention, the w/w ratio of the carbamide and the boric acid is about between 1.0-1.5:1.0. According to a further embodiment of the invention, the ratio of the carbamide and the boric acid is about 3.75:4. According to a further embodiment of the invention, the ratio of the carbamide and the boric acid is about 3.5:4. According to a further embodiment of the invention, the ratio of the carbamide and the boric acid is about 3.25:4. According to a further embodiment of the invention, the ratio of the carbamide and the boric acid is about 2.75:4. According to a further embodiment of the invention, the ratio of the carbamide and the boric acid is about 2.5:4. According to a further embodiment of the invention, the ratio of the carbamide and the boric acid is about 2.25:4. According to a further embodiment of the invention, the ratio of the carbamide and the boric acid is about 1:2.

According to an embodiment of this invention, the process of this invention may further comprises heating the a-BN to a temperature between about 1200-1800° C. under an atmosphere of nitrogen, ammonia, or both a mixture thereof, so as to provide h-BN and/or t-BN. According to one embodiment of this invention, the heating of the a-BN is performed when about 40-45% of the initial weight of the boric acid reactant remains. According to one embodiment of this invention, the heating of the a-BN is performed when about 35-40% of the initial weight of the boric acid reactant remains. According to one embodiment of this invention, the heating of the a-BN is performed when about 30-35% of the initial weight of the boric acid reactant remains. According to one embodiment of this invention, the heating of the a-BN is performed when about 25-30% of the initial weight of the boric acid reactant remains. According to one embodiment of this invention, the heating of the a-BN is performed when about 20-25% of the initial weight of the boric acid reactant remains. According to one,, embodiment of this invention, the heating of the a-BN is performed when about 15-20% of the initial weight of the boric acid reactant remains. According to one embodiment of this invention, the heating of the a-BN is performed when about 10-15% of the initial weight of the boric acid reactant remains.

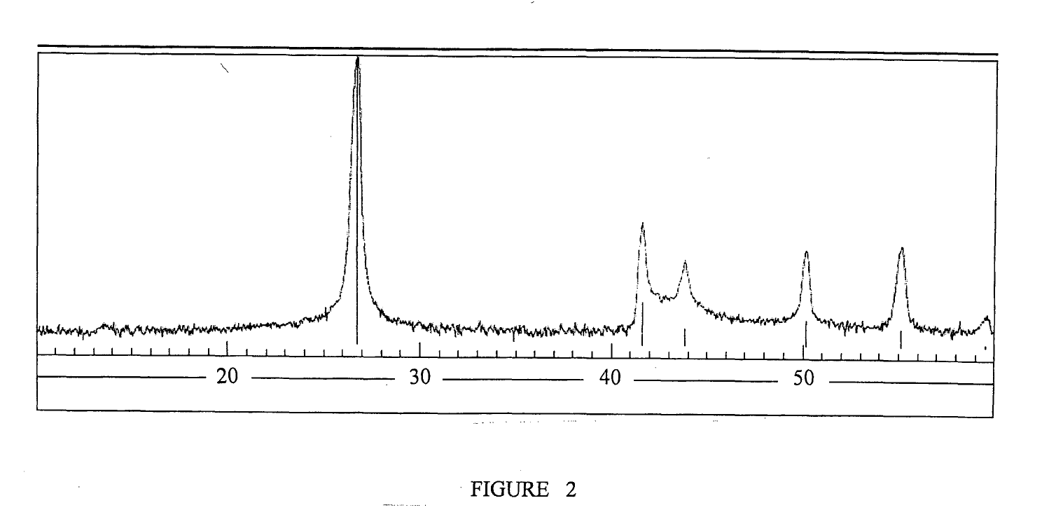

According to this invention, when lower range temperatures are used, i.e., about 1200-1400° C. the percentage of t-BN rises, while higher temperatures, i.e., about 1400-1800° C. result in lower amounts of t-BN and higher amounts of h-BN. FIG. 2 shows the XRD pattern obtained from the h-BN/t-BN powder prepared according to this invention at 1500° C.

According to an embodiment of this invention, the a-BN is ground to particles smaller than about 2-3 micron, before heating to about 1200° C.-1800° C. to prepare the h-BN/t-BN.

Once the h-BN/t-BN is prepared, according to an embodiment of the invention, the t-BN/h-BN powder is cleaned from remaining boric acid, boric anhydride, or any other contaminants, by washing with hot water in temperature that is higher than about 70° C. and/or alcohol. Since the alcohol is capable of providing cleaner material, when highly pure material is desired, according to this invention, the t-BN/h-BN is washed first with water and then with alcohol. According to a further embodiment, the washing with hot water is performed until the remaining amount of boric anhydride in the reaction vessel is less than about 0.5% w/w. According to a further embodiment, the washing with hot water is performed until the remaining amount of boric anhydride in the reaction vessel is less than about 1-2% w/w. According to a further embodiment, the washing with hot water is performed until the remaining amount of boric anhydride in the reaction vessel is less than about 2-3% w/w. According to a further embodiment, the washing with hot water is performed until the remaining amount of boric anhydride in the reaction vessel is less than about 3-4% w/w. According to a further embodiment, the washing with hot water is performed until the remaining amount of boric anhydride in the reaction vessel is less than about 4-5% w/w. According to a further embodiment, the washing with alcohol is performed until the remaining amount of boric anhydride is less than about 0.1% w/w.

According to an embodiment of the invention, the water used to wash the product materials is distilled or demineralized water, wherein the concentration of the h-BN/t-BN powder in the water is less than about 2-5%. According to another embodiment, the powder is separated from the water by centrifuge.

Once the h-BN/t-BN materials are washed there may still be up to 1% residual oxygen (not from boric anhydride) that probably results from free orbitals on the surface of the h-BN/tBN material that react with the oxygen in the air. Thus, according to a further embodiment of this invention, after the h-BN/t-BN material is washed with water and/or alcohol, it is heated to about 300° C. under a light gas, such as hydrogen or helium, thereby causing the oxygen to leave the surface. Then, under hermitic conditions, a heavier gas, such as argon or nitrogen, is streamed over the h-BN/t-BN material.

According to this invention, the h-BN/t-BN products contain up to about 2% impurities. According to another embodiment of this invention, the h-BN/t-BN product contains up to about 1% impurities. According to yet another embodiment of this invention, the h-BN/t-BN product contains up to about 0.5% impurities. According to yet another embodiment of this invention, the amount of impurities found in the h-BN/t-BN product is less than 0.5%.

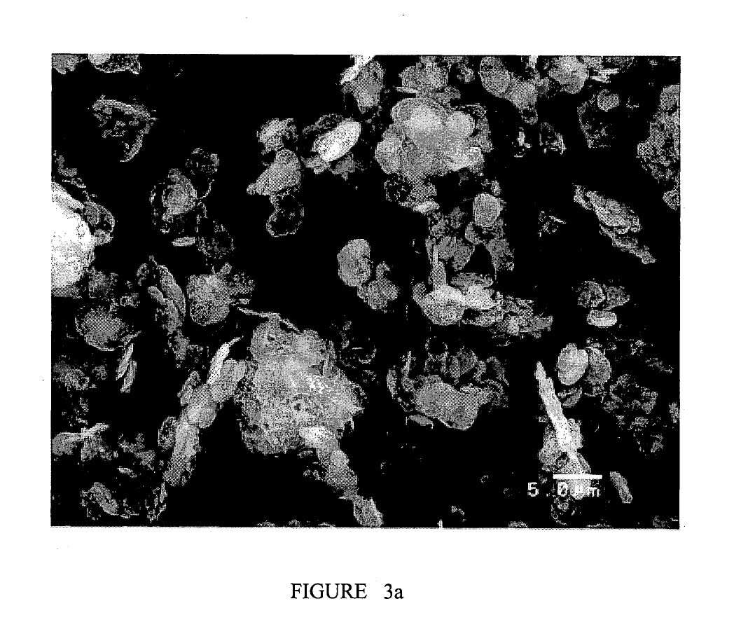

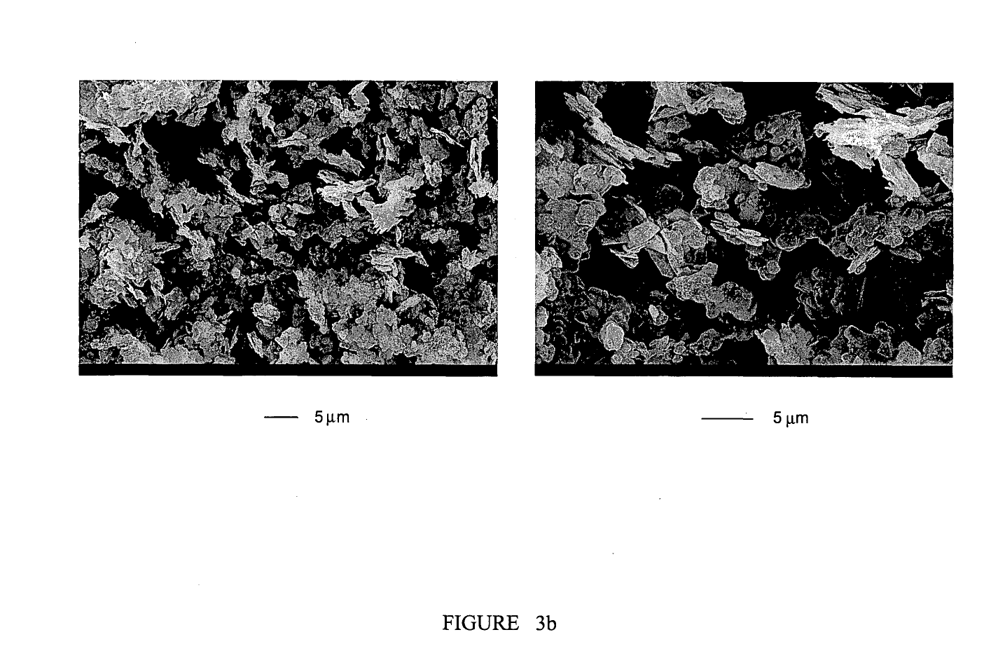

FIG. 3a shows an electron microscope picture of the h-BN/t-BN powder prepared according of this invention, demonstrating the high degree of purity of the product. FIG. 3b shows additional electron microscope pictures of the h-BN/t-BN powder prepared according to this invention. An analysis of the h-BN/t-BN powder prepared according to this invention indicates the following composition: carbon 0.053%, oxygen 0.608%, nitrogen 55.8%, calcium 280 ppm, silicon 100 ppm and sol. Borates 0.133% mean particle size of 5.5 μm.

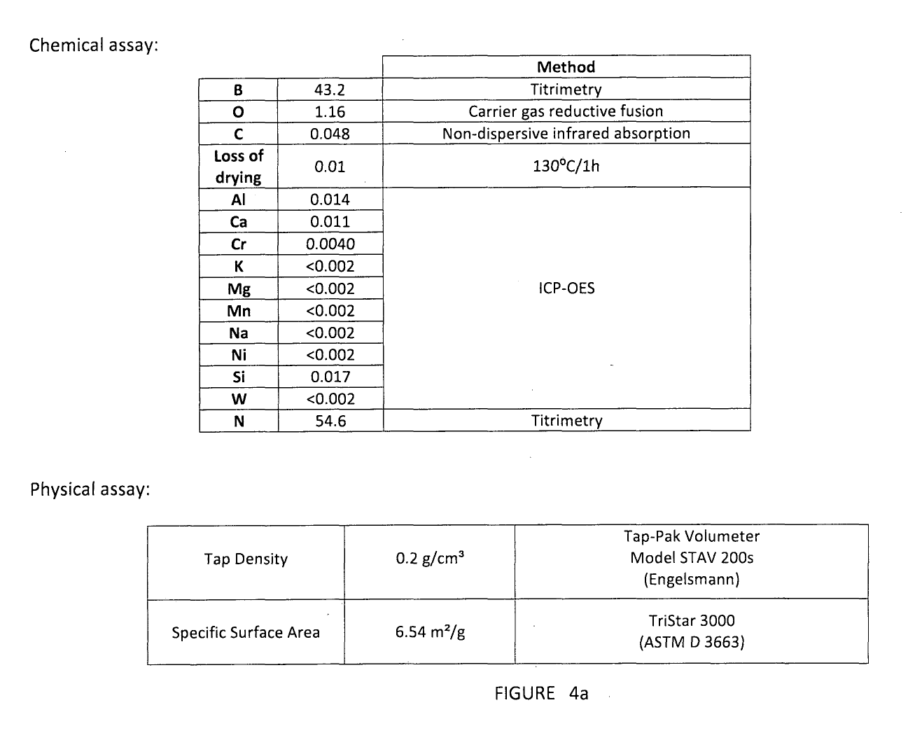

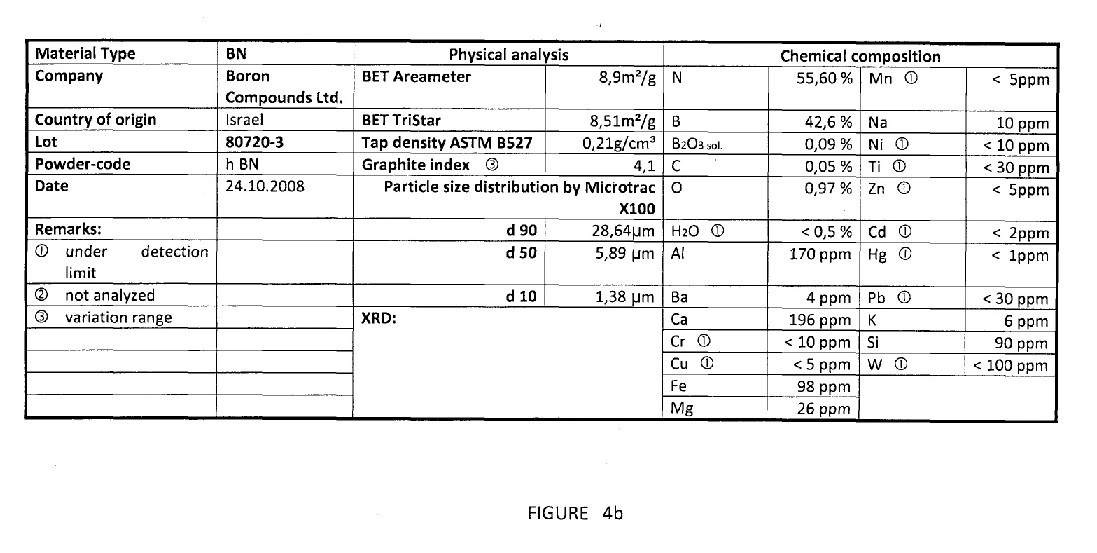

The physical and chemical properties of two different batches of the h-BN/t-BN prepared according to this invention are provided in FIGS. 4a and 4b. The time of endurance for preparing the t-BN is 1.5-3 hours at a temperature of 1200-1500° C. The time of endurance for preparing the h-BN is 3 hours at a temperature of 1500-1800° C.

Various aspects of the invention are described in greater detail in the following Examples, which represent embodiments of this invention, and are by no means to be interpreted as limiting the scope of this invention.

### EXAMPLES

### Example 1

300 g H₃BO₃ are mixed with 600 g (NH₂)₂CO at 250° C. for 2 hours and then heated to 500° C. for 0.25 hour for obtaining 120 gr of a-BN. The reaction vessel is then heated to a temperature of 1200° C. for 3 hours in a nitrogen atmosphere for obtaining 84.6 gr t-BN.

### Example 2

300 g H₃BO₃ are mixed with 600 g (NH₂)₂CO at 250° C. for 2 hours and then heated to 600° C. for 0.5 hour for obtaining 130 gr of a-BN. The reaction vessel is then heated to a temperature of 1500° C. for 2 hours under an atmosphere of nitrogen for obtaining 104.5 gr t-BN.

### Example 3

300 g H₃BO₃ are mixed with 600 g (NH₂)₂CO at 250° C. for 2 hours and then heated to 600° C. for 0.5 hour for obtaining 135 gr of a-BN. The reaction vessel is then heated to a temperature of 1500° C. for 5 hours in a nitrogen atmosphere for obtaining 101.2 gr h-BN.

### Example 4

300 g H₃BO₃ are mixed with 600 g (NH₂)₂CO at 250° C. for 2 hours and then heated to 600° C. for 1.0 hour for obtaining 132 gr of a-BN. The reaction vessel is then heated to a temperature of 1800° C. for 3 hours in a nitrogen atmosphere for obtaining 88.6 gr h-BN.

### Example 5

To simulate the process, we conducted a thermogravimetric analysis using TG-50 and a calorimetric analysis using DSC-823E. Both Analyzers of the company Mettler Toledo, USA.

For the thermogravimetric analysis 25.5600 mg of a mixture of urea and boric acid taken as a ratio of 2:1 was used. Heating was conducted from 25° C. to 1000° C. at a rate 10° C. per minute in a nitrogen atmosphere (200 ml per minute). The results indicate that heating above 600° C. for production of the amorphous BN is not effective.

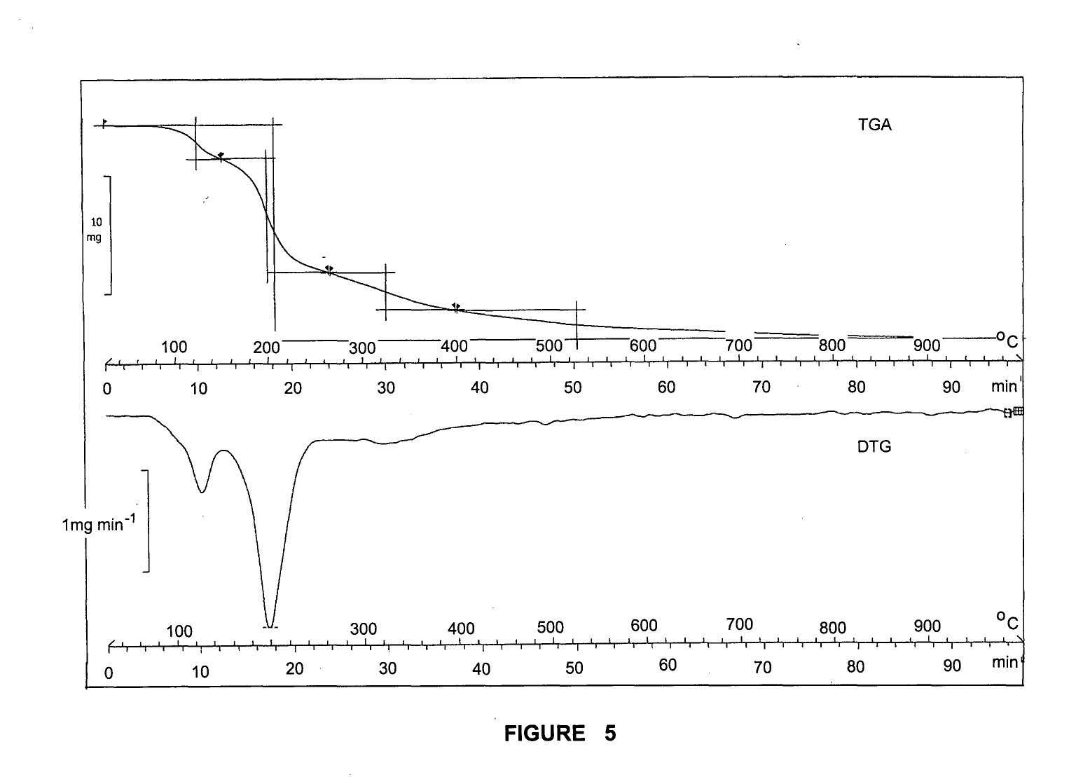

For the calorimetric analysis 6.2900 mg of a mixture of urea/boric acid, taken as a ratio of 2:1 was used. Analysis was conducted in an atmosphere of nitrogen (80 ml per minute) in the temperature range from 30° C. to 600° C. at a heating rate 10° C./min. The results are shown in FIG. 5.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A process for the preparation of amorphous boron nitride (a-BN) comprising:
a. mixing powders of boric acid and a carbamide at a temperature in the range of about 250-300° C., thereby forming: ammonium polyborates; boron imide or a mixture thereof and ammonia; and
b. heating of the materials formed in step (a) to a temperature in the range of about 500-600° C., thereby forming a powder of a-BN.

2. The process according to claim 1, wherein the ammonium polyborates reacts with the ammonia when heated to about 500-600° C. thereby forming a-BN.

3. The process according to claim 1, wherein heating the boron imide to about 500-600° C. provides a-BN.

4. The process according to claim 1, wherein the carbamide is urea.

5. The process according to claim 1, wherein step (b) is performed when about 55-75% of the initial weight of the boric acid remains in the reaction vessel.

6. The process according to claim 1, wherein step (b) is performed when about 60-65% of the initial weight of the boric acid remains in the reaction vessel.

7. The process according to claim 1, wherein the boric acid is H₃BO₃, H₂B₄O₇ or HBO₂.

8. The process according to claim 1, wherein the ammonium polyborate formed consists essentially from ammonium tetraborate.

9. The process according to claim 1, wherein the w/w ratio of the carbamide and the boric acid reactants is from about 3:4 to 2:1.

10. The process according to claim 1, wherein the w/w ratio of the carbamide and the boric acid reactants is about between 1.0-1.5:1.0.

11. The process according to claim 1, further comprising heating the a-BN to a temperature between about 1200-1800° C. under an atmosphere of nitrogen, ammonia, or a mixture thereof, thereby providing h-BN, t-BN, or a combination of h-BN and t-BN.

12. The process according to claim 11, wherein said a-BN is ground to particles smaller than about 2-3 micron prior to heating the a-BN.

13. The process according to claim 11, wherein the further heating of the a-BN is performed when about 40-45% of the initial weight of the boric acid remains in the reaction vessel.

14. The process according to claim 11, wherein remaining boric acid, boric anhydride and other contaminants are removed from the t-BN and the h-BN by washing with water, alcohol, or a mixture thereof.

15. The process according to claim 14, wherein the washing with water is performed until the remaining amount of boric anhydride is less than about 0.5% w/w.

16. The process according to claim 14, wherein the washing with alcohol is performed until when the remaining amount of boric anhydride is less than about 0.1% w/w.

17. The process according to claim 13, further comprising
heating the h-BN and t-BN to about 300° C. under a light gas; and
streaming a heavy gas over the h-BN and t-BN under hermitic conditions.
